(19) United States
(12) Patent Application Publication
(10) Pub. No.: US 2017/0046973 A1
(43) Pub. Date: Feb. 16, 2017

(54) PREVERBAL ELEMENTAL MUSIC: MULTIMODAL INTERVENTION TO STIMULATE AUDITORY PERCEPTION AND RECEPTIVE LANGUAGE ACQUISITION

(71) Applicant: Thea Kuddo, North Bethesda, MD (US)

(72) Inventor: Thea Kuddo, North Bethesda, MD (US)

(21) Appl. No.: 15/334,387

(22) Filed: Oct. 26, 2016

Related U.S. Application Data
(60) Provisional application No. 62/246,888, filed on Oct. 27, 2015.

(51) Int. Cl. G09B 19/00; G09B 15/00; G09B 5/04; G10H 1/00; G10H 1/46

(52) U.S. Cl. CPC G09B 19/00; G10H 1/0025; G10H 1/46; G09B 5/04; G09B 15/00; G10H 2210/325; G10H 2210/375; G10H 2210/341

(57) ABSTRACT

A multimodal intervention method provides instructional media that connects elements of music with non-phonemic components of spoken language to enhance receptive language acquisition and literacy learning in children with various disorders affecting language, particularly children with autism, developmental language disorders, and cochlear implant recipients. The intervention enables children with limited or no language to become meaningfully engaged in multimodal activities that encourage development of auditory cognition and cognition generally without the need for preexisting language. It uses music, to which children are naturally drawn, for exploration of connections between auditory and visual information to help them learn to differentiate and recognize objects by auditory information; compare and categorize this information; memorize and retrieve from memory; and form auditory objects. The method helps to engage both primary and higher order auditory processing simultaneously in the form of play and problem solving, and introduces children to basic reading.

### CROSS-REFERENCE TO RELATED APPLICATIONS

This application claims the benefit of the following U.S. Provisional Patent Application 62/246,888 Oct. 27, 2015 Kuddo

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

1. Field of the Invention

The present invention relates to the fields of education and music therapy, particularly to systems and methods for, and process of, preparing and applying musical compositions, and use of such compositions to treat and educate individuals with various disorders, which manifest as language impairments.

2. Background and Related Art

Communication disorders include problems related to speech, language and auditory processing. In the US, nearly 6 million children under the age of 18 have a speech or language disorder. Twenty five to 40% of children on the autism spectrum do not develop phrase speech during their lifetime, despite access to early intensive interventions. Almost all treatment approaches for autism are based mostly on social skill training and behavior modification, and rely exclusively on a top-down, direct instructional approach, with no targeting of core neuronal deficits underlying language impairments.

The development of the auditory system necessary for language acquisition begins with exposure to the sound environment before the baby is born, and continues into adolescence. Developing the ability to efficiently process auditory information, which includes building the capacity for working memory, is a prerequisite for spoken language acquisition. Auditory cognition is a set of processes by which the brain makes sense of the sound world. These processes require several brain networks to work together: auditory scene analysis, complex sound perception, visual cues, attention, auditory working memory, long-term memory, and emotional systems. The lack of language development in children should never create the automatic assumption that these children cannot learn, particularly when auditory cognition has not been addressed in interventions and education. Without learning to communicate and participate in society, these children become adults requiring lifelong round-the-clock care, leading to a poor quality of life.

Speech sounds are complex sounds. The comprehension of speech requires an ability to distinguish between different arrangements of components of sounds, including to determine spectral shape, detect and discriminate loudness and pitch, and to do so with fine temporal resolution, which addresses both longer vowels and shorter consonants. These processes require access to basic sound features, as well as detection of changes in these properties over time; speech comprehension involves higher-order tasks like forming auditory objects, localizing sounds, understanding speech, or perceiving music. It involves mapping continuous acoustic waveforms onto discrete phonological units computed to store words in the mental lexicon.

Auditory discrimination skills play a fundamental role in development of speaking, reading, language, and more complex auditory processes. Pitch contour recognition has been shown to be critically important in the acquisition of literacy as being a part of the acoustic foundation of phonological skills. The rapid auditory processing abilities of infants have been shown to be the single best predictor of language outcome at 24 months of age (Abramson and Lloyd 2016). It is therefore very important that a child has basic frequency and other sound feature discrimination skills necessary to organize the temporal and spectral aspects of the stream of speech, and associate various patterns to meaningful percepts of objects and events, before spoken language learning can become efficient by any behavioral or social skill interventions currently available.

While inefficient auditory cognition affects communication and literacy learning in numerous health conditions to various degrees, like speech and reading impairments, including dyslexia and cochlear implant rehabilitation, impaired language constitutes the hallmark feature in autism, which is one of the core domains particularly affected. Concerns related to language development are the primary reason parents seek professional help for children with autism. Receptive language deficits have been shown to be present during the first year of life. In numerous recent imaging and electrophysiologic studies, atypical auditory development has been proposed as diagnostic for autism spectrum disorders, and prognostic in terms of severity. Basic perceptual processing has been found to be delayed in both visual and auditory domains. However, higher levels of processing, including lexical-semantic functions, have been found truly impaired. Disruption in initial acoustic processing is thought to be responsible for impaired phonological processing, which is critical for efficient language development.

The first year is a foundational developmental period for acoustic feature encoding and mapping sounds to meaning—a foundation for language learning. Behaviorally, children with autism do not naturally orient to speech stimuli like other children, and therefore, do not engage fully in a natural language acquisition process. Without paying attention and showing interest in spoken language, which includes interaction and engagement, spoken language cannot develop. Importantly, typically developing infants do not respond to just any kind of speech; they prefer infant-directed speech, which is exaggerated musical speech used by mothers and caretakers. They do not understand linguistic meaning, but respond to pitch and rhythmic contours, timbre, or spectral shape; they learn to extract these patterns from auditory scene, and attach meaning to these. Infants do not learn language by building up from phonemes. They build up language by mapping sound patterns to meaning. The smallest linguistic entity with meaning is a word. Phonemes can change meanings of words, but they do not represent objects or events.

Currently available early intervention methods do not lead to language development for at least every third child on the autism spectrum. These methods encourage social interaction, but are not designed to build capacity for auditory cognitive skills necessary for understanding speech. None of these programs address auditory object formation, the fundamental perceptual unit in hearing. When children with minimal language reach school age, they become one of the most highly undeserved and understudied populations of children. They do not respond to existing language teaching methods and therefore cannot access literacy learning, despite for the fact that at least 50% of these children have nonverbal intelligence within normal limits. The lack of interventions is highlighted in the recent study by Krueger (2013) across several school districts in California, where children were found to be unengaged for most of their time at school, despite having low adult/child ratios and various specialists, including behavioral, speech, and occupational therapists on the team. Also, a subset of children with cochlear implants fail to achieve an open-set speech recognition, even after five years past implantation, due to slow auditory skill development, leading to slow development of language, reading, and academic skills. A clear and urgent need exists for an intervention model to be employed in teaching children who fail to develop functional language, so that every child with nonverbal intelligence levels can achieve literacy, and/or whose language skills would benefit from enhancing auditory cognition.

### REFERENCES

Filippi P. “Emotional and interactional prosody across animal communication systems: a comparative approach to the emergence of language”. Front Psychol. 2016 Sep. 28; 7:1393
Cantiani C, et al., “From sensory perception to lexical-semantic processing: an ERP study in non-verbal children with autism”, PLoS One. 2016 Aug. 25; 11(8):e0161637.
Mikic B, et al., “Receptive speech in early implanted children later diagnosed with autism”, Eur Ann Otorhinolaryngol Head Neck Dis. 2016 June; 133 Suppl 1:S36-9
Abramson M K, Lloyd P J. “Development of a pitch discrimination screening test for preschool children”, J Am Acad Audiol. 2016 April; 27(4):281-92
Berman J I, et al., “Multimodal diffusion-MRI and MEG assessment of auditory and language system development in autism spectrum disorder”, Front Neuroanat. 2016 Mar. 23; 10:30.
Edgar J C, et al., “Auditory encoding abnormalities in children with autism spectrum disorder suggest delayed development of auditory cortex”, Mol Autism. 2015 Dec. 30; 6:69.
Lichtenberg J D, Lachmann F M, Fosshage J L, “Enlivening the Self: The First Year, Clinical Enrichment, and The Wandering Mind, Routledge 2015.
J M Barnard, et al., “A Prospective, Longitudinal Study of US Children Unable to Achieve Open-Set Speech Recognition Five Years after Cochlear Implantation”, Otol Neurotol. Author manuscript; available in PMC 2016 Jul. 1. Published in final edited form as: Otol Neurotol. 2015 July; 36(6): 985-992
Lombardo M V, et al., “Different functional neural substrates for good and poor language outcome in autism”, Neuron. 2015 Apr. 22; 86(2):567-77.
Asano M, et al., “Sound symbolism scaffolds language development in preverbal infants”. Cortex. 2015 February; 63:196-205.
Christison-Lagay K L, Gifford A M, Cohen Y E. “Neural correlates of auditory scene analysis and perception”, Int J Psychophysiol. 2015 February; 95(2):238-45.
Thurm A, et al., “Longitudinal study of symptom severity and language in minimally verbal children with autism”, J Child Psychol Psychiatry. 2015 January; 56(1):97-104
Alho K, et al., “Stimulus-dependent activations and attention-related modulations in the auditory cortex: a meta-analysis of fMRI studies”, Hear Res. 2014 January; 307:29-41
Grube M, Cooper F E, Griffiths T D. “Auditory temporal-regularity processing correlates with language and literacy skill in early adulthood”, Cogn Neurosci. 2013; 4(3-4):225-30.
Tager-Flusberg H, Kasari C. “Minimally verbal school-aged children with autism spectrum disorder: the neglected end of the spectrum”, Autism Res. 2013 December; 6(6):468-78.
Bizley J K, Cohen Y E. “The what, where and how of auditory-object perception”. Nat Rev Neurosci. 2013 October; 14(10):693-707
Estes K G, Hurley K. “Infant-directed prosody helps infants map sounds to meanings”, Infancy. 2013 Sep. 1; 18(5)
Graf Estes K, Bowen S. “Learning about sounds contributes to learning about words: effects of prosody and phonotactics on infant word learning”, J Exp Child Psychol. 2013 March; 114(3):405-17
Krueger, Kathryne Kelley, (2013) “Minimally verbal school-aged children with autism: communication, academic engagement and classroom quality”, UCLA: Education 0249. Retrieved from: http://escholarship.org/uc/item/1329g9pk
Curtin S, Campbell J, Hufnagle D. Mapping novel labels to actions: how the rhythm of words guides infants' learning”, J Exp Child Psychol. 2012 June; 112(2):127-40
Lai G, et al., “Neural systems for speech and song in autism”, Brain. 2012 March; 135(Pt 3):961-75.
Shukla M, White K S, Aslin R N. “Prosody guides the rapid mapping of auditory word forms onto visual objects in 6-mo-old infants”, Proc Natl Acad Sci USA. 2011 Apr. 12; 108(15):6038-43

### BRIEF SUMMARY

The principal objective of the invention uses an intervention model to provide a method (both system and process) that combines elements of language with elements of music, using various media in various settings (including but not limited to apps, sheet music, music lessons, speech therapy, occupational therapy, preschools, schools, and home use) to enhance and support teaching language/vocabulary to people of all ages with language impairments, those needing to sharpen auditory cognitive skills, and particularly young children with nonverbal intelligence within normal limits who do not respond to existing early intensive behavioral and social skill interventions in terms of language outcome. This intervention also targets individuals with other communication disorders, cochlear implant recipients, posttraumatic stress disorder, brain trauma, stroke, and those needing to improve foreign language acquisition through enhanced auditory decoding skills. The intervention model provides instructional media, including instructive components that are portable, simple, and non-confusing.

The theoretical basis for the invention model is based on knowledge from: (1) infant research on how language develops during the first year of life; (2) neuroscience and psychology studies showing that music and language share cognitive and neural systems; that musical and language stimuli activate the same areas in the brain; and that both rely on auditory modality, perception, and production of a sound; (3) imaging and electrophysiology studies on autism and other neurodevelopmental and language disorders suggesting that auditory processing difficulties are central in language impairments. Many of these studies have called for including music in interventions.

The invention employs multimodal interaction as a way to target the components of language acquisition that take place during the first year(s) of life in typically developing infants, and to enhance and support receptive language acquisition and literacy learning in children with various disorders affecting language, particularly in autism and cochlear implant recipients by: (1) building differentiation skills to acoustic features of spoken words like pitch contour, rhythm contour, and spectral shape using shared features between spoken language and music; (2) mapping musical sound patterns onto meanings; (3) supporting auditory object formation; (4) building capacity for working memory; (5) using general nonlinguistic auditory processing before linguistic meaning; (6) include affective components of music to draw attention and interest.

The focus of the invention—the intervention model—is on the multimodal interaction targeting non-phonemic features of spoken language that support various language functions. This includes extracting meaningful sounds from the auditory scene, phonological processing, which naturally develops through interactions between mother and infant during the first year of life, such as pitch, infra-pitch/rhythm, timbre, prosody, patterns, accents, and sequences, and learning about the structure of language. The non-phonemic features of spoken language segments are presented as musical stimuli in relation to visual objects, to be analyzed at both basic and higher order auditory and audiovisual processing levels, and which support and enhance the receptive language acquisition. In addition, the intervention model provides a specific way to enhance cognitive development in nonverbal or minimally verbal individuals without language skills, who cannot use language for developing thinking skills and problem solving capacity.

One of the basic elements of the invention is the system for creating musical representations of spoken words from basic vocabulary. The system provides the means to combine composing, configuring, and creating predetermined forms of musical representations of spoken words in a way that can be used for expanding language from basic vocabulary to word combinations and phrases. Prerecorded musical word representations encourage differentiation and recognition of a high variety of spectral shapes. These are then associated with visual objects by use of various musical instruments (including acoustic violin, which has the closest acoustic properties to human voice) to provide the complexity of natural rich sounds to be decoded, considering that speech sounds are highly complex and variable. Musical representations of spoken words include syllabic rhythm and accents of each corresponding word with which they are paired. Pairing music compositions with visual objects supports formation of auditory objects and symbolic thinking, and helps connect visual objects with written words.

The intervention model enables children with limited language to become meaningfully engaged in multimodal activities that encourage development of auditory cognition and cognition generally without the need for preexisting language knowledge. It uses music, which children are naturally drawn to, to encourage connections between auditory and several forms of visual information; to help them learn to differentiate and recognize objects by auditory information; to compare and categorize this information by spectral shape, pitch contour, and rhythm contour; to memorize and retrieve from memory; and to form auditory objects as symbols representing objects. The intervention model engages both primary and higher order auditory processing simultaneously, in the form of play and problem solving, and encourages children to make a connection with basic reading activities.

### BRIEF DESCRIPTION OF DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional detail through use of the accompanying drawings:

FIG. 1 illustrates the method of multimodal intervention showing the relationships, sequences, and integration of the visual, auditory, kinesthetic, cognitive domains in preverbal music with visual cues helping to make an association between auditory and visual object;

FIG. 2 illustrates the method of multimodal intervention showing the relationships, sequences, and integration of the visual, auditory, kinesthetic, cognitive domains in preverbal music when visual cues are removed, so that auditory memory can be employed.

### DETAILED DESCRIPTION OF INVENTION

The invention is a method that includes a system and process of multimodal intervention. It combines elements of language with elements of music, using various media in various settings (including but not limited to apps, sheet music, music lessons, speech therapy, occupational therapy, preschools and schools, home use) to enhance and support teaching language/vocabulary/word combinations/sentences to people of all ages with language impairments, and/or those in need of sharpening auditory cognitive skills, particularly young children with nonverbal intelligence within normal limits who do not respond to existing early intensive behavioral and social skill interventions in terms of language outcome. The intervention also targets individuals with other communication disorders, cochlear implant recipients, posttraumatic stress disorder, brain trauma, stroke, and those needing to improve foreign language acquisition through enhanced auditory decoding skills. The intervention model provides instructional media including instructive components that are portable, simple, and non-confusing, and enables engagement by individuals who cannot use language for communication.

The invention employs multimodal interaction as a way to target components of language acquisition that, in typically developing infants, take place during the first year(s) of life, and without which receptive language learning is not fully achievable. The intervention model enables an individual with or without language impairment to enhance and support the receptive language acquisition and literacy by: (1) building differentiation skills to acoustic features of spoken words like pitch contour, rhythm contour, and spectral shape using shared features between spoken language and music; (2) mapping musical sound patterns onto meanings; (3) supporting auditory object formation; (4) building capacity for working memory; (5) using general nonlinguistic auditory processing before linguistic meaning; (6) including affective components of music to draw attention and interest; (7) to extract meaningful sounds from the auditory scene.

The focus of the intervention model is the non-phonemic features of spoken language, which support various language functions. These include phonological processing, which naturally develops through interactions between mother and infant during the first year of life, such as pitch, infra-pitch/rhythm, timbre, prosody, patterns, accents, and sequences. These are presented systematically as specially composed and configured musical stimuli in relation to visual objects, to be identified and analyzed at both basic and higher order auditory and audiovisual processing levels, and which support and enhance receptive language acquisition. In addition, the intervention model provides a specific way to enhance cognitive development in nonverbal or minimally verbal individuals without language skills, who cannot use language to develop thinking skills and problem solving capacity.

The core of the invention is the system for creating compositions of musical representations of spoken words from basic vocabulary, word combinations, and phrases. Music is used instead of words because individuals with language impairments, particularly nonverbal or minimally verbal children, do not have efficient auditory cognition enabling them to process complex sounds of speech, but they are able respond to music (similar to infant language development, where musical aspects of language/prosody are first identified and analyzed). The system provides a way to compose, configure, and create both undetermined and predetermined forms of musical representations of spoken words in a way that includes non-phonemic features of spoken words. When these are combined, they can be used meaningfully for expanding language from basic vocabulary to word combinations and phrases. The musical representations of spoken words include syllabic rhythm and accents of each corresponding word with which they are paired. Each musical representation of a corresponding word has a first pitch, dependent on the number of syllables. The compositions take account multiple acoustic features: pitch contour, frequency range of speech of various speakers, rhythmic contour, tempo elements, loudness/volume dynamics, spectral shape variety or timbre, accents, extraction of meaningful information form the auditory scene. Vocabulary category, melodic and rhythmic contours, and accents are matched with the prosody of the spoken word/word combination/phrase. Pairing these music compositions with visual objects supports formation of auditory objects and symbolic thinking, and helps to connect visual objects with written words.

Prerecorded musical word representations in apps and other electronic media encourage differentiation and recognition of a high variety of spectral shapes. These are associated with visual objects by use of various musical instruments for recording (including acoustic violin, which has the closest acoustic properties compared to the human voice) to provide complexity of natural rich sounds to be decoded, considering that speech sounds are highly complex and variable. Sheet music for basic vocabulary, word combinations, and phrases provides a way to use the intervention model in music education and music therapy to enhance language acquisition in multimodal naturalistic settings.

The intervention model enables children with limited language to become meaningfully engaged in multimodal activities that encourage development of auditory cognition, and cognition generally, without the need for preexisting language knowledge. The model uses music, which children are naturally drawn to, to encourage connections between auditory information and several forms of visual information; to help them learn to differentiate and recognize objects by auditory information; to compare and categorize this information by spectral shape, pitch contour, and rhythm contour; to memorize and retrieve from memory; and to form auditory objects as symbols representing objects. The ability to extract meaningful sounds from auditory scene and cognitive skills, including comparison, categorization, pattern-finding, and introduction of symbolic thinking, are developed through exploration of specifically designed musical compositions. In these compositions, pitch contour, rhythm, and accents of spoken language segments—words, phrases, sentences—are incorporated into specially composed elemental music segments and presented in a way that audiovisual, tactile, proprioceptive, and motor functions are simultaneously employed during the completion of tasks. The intervention model engages both primary and higher order auditory processing simultaneously, in the form of play and problem solving, and encourages children to make a connection with basic reading activities.

Vocabulary is introduced by categories, e.g., animals, fruits and vegetables, house, colors, verbs, numbers, word combinations, phrases, sentences, etc. Instead of an actual spoken word, a corresponding elemental musical expression segment is composed, so that a perceptual unit, an auditory object can be formed. The pitch of the first note is dependent on the number of syllables of that particular word. Rhythm and accents match the syllabic rhythm and accents of the spoken word; various sound frequencies using a variety of musical instruments are employed for both auditory contrast and to match speaking frequencies of spoken language by gender. First, auditory complex signals are presented with different timbres and played by different musical instruments to enable easier acoustic differentiation. Visual cues are used for certain tasks, which will be later faded to promote only auditory analysis. Step by step, the musical compositions become more similar and harder to discriminate. Visual objects are presented simultaneously with corresponding musical compositions. For audiovisual processing, the visual effects are employed for the duration of auditory stimuli to draw attention to the sound—object connection. The associations between musical representations of spoken words and visual objects will be used later to include spoken word, and introduce reading via written word/musical representation of spoken word/visual object associations.

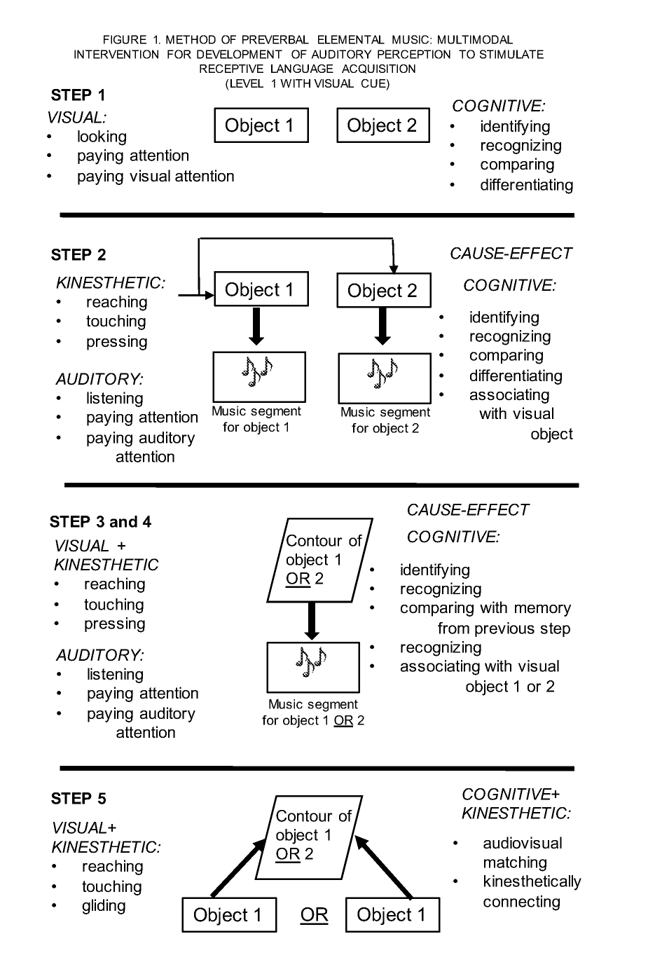

Invention used in apps and other electronic media: FIG. 1 illustrates the method of multimodal intervention, showing relationships, sequences, and integration of the visual, auditory, kinesthetic, and cognitive domains in preverbal music with visual cues in the form of a contour of a corresponding visual object, to help to make an association between auditory and visual object, so that the auditory system use is essential for answering the music segment questions in relation to visual objects. (1) Step one illustrates the use of a visual domain where a child looks at different visual objects, identifies, recognizes, and differentiates them by their visual characteristics; (2) step two illustrates integration of visual, kinesthetic, auditory, and cognitive functions with exposure to the concept of cause-effect; reaching, touching and pressing of the object on the screen results in an audible composed and configured prerecorded music segment, which contains syllabic rhythm and accents of the corresponding spoken word, but where word is not actually spoken, and only non-phonemic features of the word are used and recorded, using a variety of musical instruments with different spectral shapes, including acoustic violin, piano, xylophone, and keyboard; a child is expected to notice that, when touching different objects on the screen, different sound segments become audible; by differentiating these sound segments by their acoustic features, whether by timbre, rhythmic, or melodic contour, a child is expected to make an association between a sound segment and a corresponding visual object, and form an auditory perceptual unit—an auditory object representing the visual object with which it is associated; (3) steps 3 and 4 illustrate the integration of visual, kinesthetic, auditory, and cognitive domains, with the addition of auditory working memory function, with the help of a visual cue; reaching, touching and pressing of the general question area on the screen results in an audible composed and configured prerecorded music segment, which has been introduced in the previous activity or activities, and can be retrieved from memory where an auditory object was encouraged to be formed by associating patterns of acoustic features of sound segments, whether by timbre, rhythmic, or melodic contour, or all in different combinations that a child was exposed to previously, to visual objects; (4) step five illustrates integration of all the domains described above for solving a problem; when a child recognizes the visual object by listening, the musical representation of the spoken word for that visual object with the help of visual cues, he or she drags the correct visual object into the question area, which was previously used by reaching, touching, pressing to induce the audible music segment as a question to be answered.

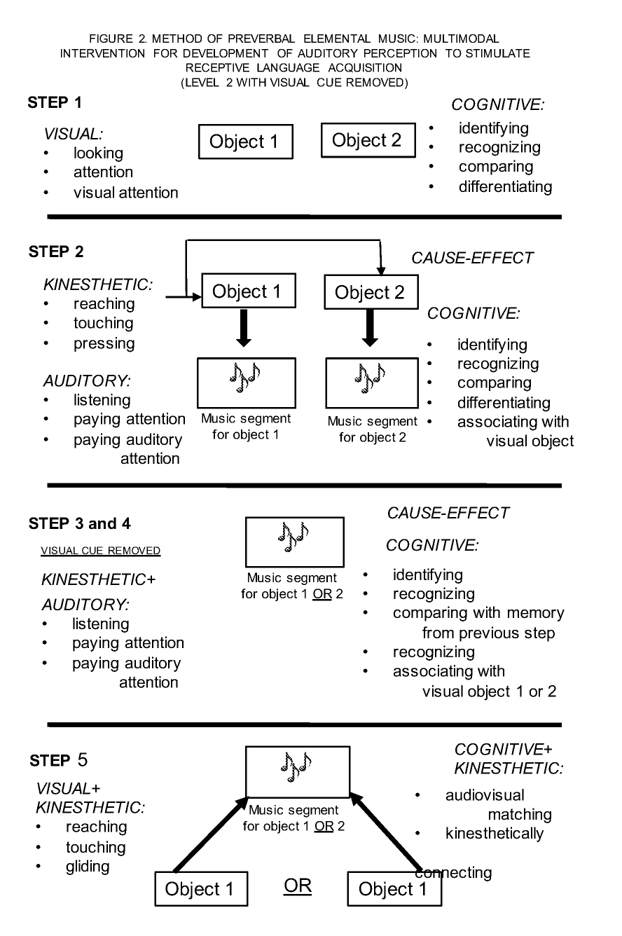

FIG. 2 illustrates the method of multimodal intervention, showing relationships, sequences, and integration of the visual, auditory, kinesthetic, and cognitive domains in preverbal music without visual cues to help to make an association between auditory and visual object, so that the auditory system use is essential for answering the music segment questions in relation to visual objects. (1) Step one illustrates the use of a visual domain where a child looks at different visual objects, identifies, recognizes, and differentiates them by their visual characteristics; (2) step two illustrates integration of visual, kinesthetic, auditory, and cognitive functions with exposure to the concept of cause-effect; reaching, touching and pressing of the object on the screen results in an audible composed and configured prerecorded music segment, which contains syllabic rhythm and accents of the corresponding spoken word, but where word is not actually spoken, and only non-phonemic features of the word are used and recorded, using a variety of musical instruments with different spectral shapes, including acoustic violin, piano, xylophone, and keyboard; a child is expected to notice that, when touching different objects on the screen, different sound segments become audible; by differentiating these sound segments by their acoustic features, whether by timbre, rhythmic, or melodic contour, a child is expected to make an association between a sound segment and a corresponding visual object, and form an auditory perceptual unit—an auditory object representing the visual object with which it is associated; (3) steps 3 and 4 illustrate the integration of visual, kinesthetic, auditory, and cognitive domains, with the addition of auditory working memory function, but without the help of a visual cue; reaching, touching and pressing of the general question area on the screen results in an audible composed and configured prerecorded music segment, which has been introduced in the previous activity or activities, and can be retrieved from memory where an auditory object was encouraged to be formed by associating patterns of acoustic features of sound segments, whether by timbre, rhythmic, or melodic contour, or all in different combinations that a child was exposed to previously, to visual objects; (4) step five illustrates integration of all the domains described above for solving a problem; when a child recognizes the visual object by listening without visual cues, the condition where the function of auditory analyzer is necessary, the musical representation of the spoken word for that visual object, he or she drags the correct visual object into the question area, which was previously used by reaching, touching, pressing to induce the audible music segment as a question to be answered.

By arranging objects according to the hierarchy of word complexity, starting from the high acoustic feature and syllabic contrasts and decreasing these gradually, encourages auditory perception and cognition development necessary for understanding complex speech sounds and their combinations. After the associations of musical representations of spoken words have been made with visual objects, and auditory objects representing these visual objects formed, the same associations are used to switch from a visual picture object to a visual written word object. This allows reading to be introduced at the same time as learning basic vocabulary, the skill which enables access to literacy and information regardless of the developmental level of speech.

Invention in music lessons, music therapy, or other educational settings: touching of the screen is replaced with touching and replacing actual toys or pictures of objects, or, later, written word cards from one location to another and pressing piano or keyboard keys, or playing the violin instead of dragging objects on the screen. The principle is the same: forming musical auditory objects for spoken words, playing them on an instrument, and recognizing objects by music segments containing syllabic rhythm, and accents of corresponding spoken words of these objects.

The intervention model enables children with limited language to become meaningfully engaged in multimodal activities that encourage development of auditory cognition and cognition generally without the need for preexisting language knowledge. It uses music, which children are naturally drawn to, to encourage connections between auditory and several forms of visual information; to help them learn to differentiate and recognize objects by auditory information; to compare and categorize this information by spectral shape, pitch contour, and rhythm contour; to memorize and retrieve from memory; and to form auditory objects as symbols representing objects. The intervention model engages both primary and higher order auditory processing simultaneously, in the form of play and problem solving, and encourages children to make a connection with basic reading activities.

I claim:

1. A method for composing music for therapeutic application to induce individuals' ability to process auditory information, including extracting meaningful auditory information from the auditory scene, and stimulating auditory perception comprising:
creating, composing, producing and incorporating musical segments being configured to correspond to spoken language segments into musical compositions wherein further comprising:
creating, composing, producing and incorporating pitch contour being configured to correspond to a spoken language segment into a musical composition;
creating, composing, producing and incorporating pitch contour being configured to increase attention to similarities between musical segment and spoken language segment;
creating, composing, producing and incorporating pitch contour being configured to increase attention to differences between musical segment and spoken language segment;
creating, composing, producing and incorporating pitch contour being configured to increase attention to similarities between musical segments and spoken language segments;
creating, composing, producing and incorporating pitch contour being configured to increase attention to differences between musical segments and spoken language segments;
incorporating selected frequencies being configured to stand out from the auditory scene to constructively interact with an individual's ability to extract meaningful auditory information from the auditory scene in various listening conditions;
incorporating selected frequencies being configured to match frequency ranges of various speakers of language to stimulate auditory object formation to different spoken language frequency ranges of various speakers during auditory perception;
incorporating selected frequencies being configured to match frequency ranges of various speakers of language to stimulate auditory object recognition of different spoken language frequency ranges of various speakers during auditory perception;
incorporating selected frequencies being configured to increase attention to components of auditory scene;
incorporating selected frequencies being configured to increase attention to similarities between musical segments and spoken language segments;
incorporating selected frequencies being configured to increase attention to differences between musical segments and spoken language segments;
incorporating selected frequencies being configured to increase attention to similarities and differences between different musical segments and different spoken language segments;
incorporating selected frequency ranges into the musical composition being configured to increase generalization of auditory information;
creating, composing, producing and incorporating tempo elements being configured to correspond to a spoken language segment into a musical composition:
incorporating tempo elements into the musical composition being configured to interact with an individual's ability to extract meaningful auditory information from the auditory scene in various listening conditions and stimulate auditory perception;
incorporating tempo elements into the musical composition being configured to stimulate auditory object formation during auditory perception;
incorporating tempo elements into the musical composition being configured to increase attention to components of auditory scene;
incorporating tempo elements into the musical composition being configured to increase attention to similarities between musical segments and spoken language segments;
incorporating tempo elements into the musical composition being configured to increase attention to differences between musical segments and spoken language segments;
incorporating tempo elements into the musical composition being configured to increase attention to similarities and differences between different musical segments and different spoken language segments;
incorporating tempo elements into the musical composition being configured to increase generalization of auditory information;
creating, composing, producing and incorporating various timbres being configured to correspond to a spoken language segment into a musical composition:
incorporating various timbres into the musical composition being configured to interact with an individual's ability to extract meaningful auditory information from the auditory scene in various listening conditions and stimulate auditory perception;
incorporating various timbres into the musical composition being configured to stimulate auditory object formation during auditory perception;
incorporating various timbers into the musical composition being configured to increase attention to components of auditory scene;
incorporating various timbers into the musical composition being configured to increase generalization of auditory information;
creating, composing, producing and incorporating frequency spectrum being configured to correspond to a spoken language segment into a musical composition:
incorporating frequency spectrum into the musical composition being configured to interact with an individual's ability to extract meaningful auditory information from the auditory scene in various listening conditions;
incorporating frequency spectrum into the musical composition being configured to match speaking frequencies of various speakers to constructively stimulate auditory perception;
incorporating frequency spectrum into the musical composition being configured to match speaking frequencies of various speakers to constructively stimulate generalization of auditory information across different speakers;
incorporating frequency spectrum into the musical composition being configured to match speaking frequencies of various speakers to increase attention to similarities and/or differences between musical segments and language segments;
creating, composing, producing and incorporating rhythm elements being configured to correspond to a spoken language segment into a musical composition:
incorporating rhythmic pattern of a corresponding language segment into the musical composition, rhythmic pattern being configured to interact with an individual's ability to extract meaningful auditory information from the auditory scene;
incorporating rhythm elements into the musical composition being configured to match rhythm elements of corresponding language segment to increase attention to similarities and/or differences between musical segments and language segments;
incorporating rhythm elements of a corresponding language segment into the musical composition, rhythm elements being configured to interact with an individual's attention to components of auditory scene;
incorporating accents of a corresponding language segment into the musical composition, accents being configured to interact with an individual's ability to extract meaningful auditory information from the auditory scene;
incorporating accents of a corresponding language segment into the musical composition, accents being configured to stimulate segmentation of speech stream into smaller units and constructively interact with an individual's auditory perception;
incorporating accents of a corresponding language segment into the musical composition, accents being configured to interact with an individual's attention to components of auditory scene;
creating, composing, producing and incorporating volume dynamics being configured to correspond to a spoken language segment into a musical composition:
incorporating volume dynamics of a corresponding language segment into the musical composition, the changes of volume being configured to interact with an individual's ability to extract meaningful auditory information from the auditory scene;
incorporating volume dynamics of a corresponding language segment into the musical composition, the changes of volume being configured to interact with an individual's ability to connect auditory information to the sound source;
incorporating volume dynamics of a corresponding language segment into the musical composition, the changes of volume being configured to stimulate dynamic adaptation within auditory perception and incorporating volume dynamics of a corresponding language segment into the musical composition, the changes of volume being configured to stimulate sound localization during auditory perception.

2. A method for composing music for therapeutic application to improve individuals' ability to process auditory information, including extracting meaningful auditory information from the auditory scene, and stimulating auditory perception comprising:
creating, composing, producing and incorporating musical segments being configured to correspond to spoken language segments into musical compositions;
creating, composing, producing and incorporating pitch contour being configured to correspond to a spoken language segment into a musical composition;
creating, composing, producing and incorporating pitch contour being configured to increase attention to similarities between musical segment and spoken language segment;
creating, composing, producing and incorporating pitch contour being configured to increase attention to differences between musical segment and spoken language segment;
creating, composing, producing and incorporating pitch contour being configured to increase attention to similarities between musical segments and between spoken language segments;
creating, composing, producing and incorporating pitch contour being configured to increase attention to differences between musical segments and between spoken language segments;
incorporating selected frequencies being configured to stand out from the auditory scene to constructively interact with an individual's ability to extract meaningful auditory information from the auditory scene in various listening conditions;
incorporating selected frequencies being configured to match frequency ranges of various speakers of language to stimulate auditory object formation to different spoken language frequency ranges of various speakers during auditory perception;
incorporating selected frequencies being configured to match frequency ranges of various speakers of language to stimulate auditory object recognition of different spoken language frequency ranges of various speakers during auditory perception;
incorporating selected frequencies being configured to increase attention to components of auditory scene;
incorporating selected frequencies being configured to increase attention to similarities between musical segments and spoken language segments;
incorporating selected frequencies being configured to increase attention to differences between musical segments and spoken language segments;
incorporating selected frequencies being configured to increase attention to similarities and differences between different musical segments and different spoken language segments;
incorporating selected frequency ranges into the musical composition being configured to increase generalization of auditory information;
creating, composing, producing and incorporating tempo elements being configured to correspond to a spoken language segment into a musical composition:
incorporating tempo elements into the musical composition being configured to interact with an individual's ability to extract meaningful auditory information from the auditory scene in various listening conditions and stimulate auditory perception;
incorporating tempo elements into the musical composition being configured to stimulate auditory object formation during auditory perception;
incorporating tempo elements into the musical composition being configured to increase attention to components of auditory scene;
incorporating tempo elements into the musical composition being configured to increase attention to similarities between musical segments and spoken language segments;
incorporating tempo elements into the musical composition being configured to increase attention to differences between musical segments and spoken language segments;
incorporating tempo elements into the musical composition being configured to increase attention to similarities and differences between different musical segments and different spoken language segments;
incorporating tempo elements into the musical composition being configured to increase generalization of auditory information;
creating, composing, producing and incorporating various timbers being configured to correspond to a spoken language segment into a musical composition:
incorporating various timbres into the musical composition being configured to interact with an individual's ability to extract meaningful auditory information from the auditory scene in various listening conditions and stimulate auditory perception;
incorporating various timbres into the musical composition being configured to stimulate auditory object formation during auditory perception;
incorporating various timbers into the musical composition being configured to increase attention to components of auditory scene;
incorporating various timbers into the musical composition being configured to increase generalization of auditory information;
creating, composing, producing and incorporating frequency spectrum being configured to correspond to a spoken language segment into a musical composition:
incorporating frequency spectrum into the musical composition being configured to interact with an individual's ability to extract meaningful auditory information from the auditory scene in various listening conditions;
incorporating frequency spectrum into the musical composition being configured to match speaking frequencies of various speakers to constructively stimulate auditory perception;
incorporating frequency spectrum into the musical composition being configured to match speaking frequencies of various speakers to constructively stimulate generalization of auditory information across different speakers;
incorporating frequency spectrum into the musical composition being configured to match speaking frequencies of various speakers to increase attention to similarities and/or differences between musical segments and language segments;
creating, composing, producing and incorporating rhythm elements being configured to correspond to a spoken language segment into a musical composition:
incorporating rhythmic pattern of a corresponding language segment into the musical composition, rhythmic pattern being configured to interact with an individual's ability to extract meaningful auditory information from the auditory scene;
incorporating rhythm elements into the musical composition being configured to match rhythm elements of corresponding language segment to increase attention to similarities and/or differences between musical segments and language segments;
incorporating rhythm elements of a corresponding language segment into the musical composition, rhythm elements being configured to interact with an individual's attention to components of auditory scene;
incorporating accents of a corresponding language segment into the musical composition, accents being configured to interact with an individual's ability to extract meaningful auditory information from the auditory scene;
incorporating accents of a corresponding language segment into the musical composition, accents being configured to stimulate segmentation of speech stream into smaller units and constructively interact with an individual's auditory perception;
incorporating accents of a corresponding language segment into the musical composition, accents being configured to interact with an individual's attention to components of auditory scene;
creating, composing, producing and incorporating volume dynamics being configured to correspond to a spoken language segment into a musical composition;
incorporating volume dynamics of a corresponding language segment into the musical composition, the changes of volume being configured to interact with an individual's ability to extract meaningful auditory information from the auditory scene;
incorporating volume dynamics of a corresponding language segment into the musical composition, the changes of volume being configured to interact with an individual's ability to connect auditory information to the sound source;
incorporating volume dynamics of a corresponding language segment into the musical composition, the changes of volume being configured to stimulate dynamic adaptation within auditory perception and
incorporating volume dynamics of a corresponding language segment into the musical composition, the changes of volume being configured to stimulate sound localization during auditory perception.

3. A method as recited in claim 1, wherein the pitch contour, tempo elements, various timbres, variable frequency spectrum, changes in rhythmic pattern, variable accents, changes in volume dynamics are selected and configured to activate and increase attention to auditory signals in auditory perception system.

4. A method as recited in claim 1, wherein the pitch contour, tempo elements, various timbres, variable frequency spectrum, changes in rhythmic pattern, variable accents, changes in volume dynamics are selected and configured to activate and increase attention to meaningful auditory signals in auditory perception system.

5. A method as recited in claim 1, wherein the pitch contour, tempo elements, various timbres, variable frequency spectrum, changes in rhythmic pattern, variable accents, changes in volume dynamics are selected and configured to deactivate and decrease attention to background auditory signals in auditory perception system.

6. A method as recited in claim 1, wherein the pitch contour, tempo elements, various timbres, variable frequency spectrum, changes in rhythmic pattern, variable accents, changes in volume dynamics are selected and configured to activate and increase attention to meaningful auditory signals in auditory perception system.

7. A method as recited in claim 1, wherein the pitch contour, tempo elements, various timbres, variable frequency spectrum, changes in rhythmic pattern, variable accents, changes in volume dynamics are selected and configured to simulate ability to differentiate between speech and non-speech sounds.

8. A method as recited in claim 1, wherein the pitch contour, tempo elements, various timbres, variable frequency spectrum, changes in rhythmic pattern, variable accents, changes in volume dynamics are selected and configured to simulate overall attention.

9. A method as recited in claim 1, wherein the pitch contour, tempo elements, various timbres, variable frequency spectrum, changes in rhythmic pattern, variable accents, changes in volume dynamics are selected and configured to simulate pre-verbal language.

10. A method as recited in claim 1, wherein the pitch contour, tempo elements, various timbres, variable frequency spectrum, changes in rhythmic pattern, variable accents, changes in volume dynamics are selected and configured to simulate sound localization.

11. A method as recited in claim 1, wherein the auditory object of corresponding language segments comprise pitch contour, tempo, various timbres, variable frequency spectrum, changes in rhythmic pattern, variable accents, changes in volume dynamics elements consistent with elements of infant directed speech in mother baby interaction during the first year of life.

12. An electronic screen device for improving multimodal integration during multisensory perception and self-regulatory auto-stimulation capacities, said device comprising:
an electronic medium for storing an audiovisual program with a kinetic element, wherein said audiovisual program with kinetic element comprising:
musical, vocal, spoken and visual language elements, visual objects configured to constructively interact with human perception;
compositional elements configured to constructively interact with an individual's perception of visual and/or auditory stimuli in the presence of kinesthetic component in such a way as to strengthen the multimodal integration of auditory-visual-proprioceptive-kinesthetic processing and perception;
an electronic interactive screen device for displaying visual objects;
an electronic device or a component of a device for playing audio and
a device or a component of a device for kinesthetic use of screen device.

13. The electronic screen device as recited in claim 12, wherein the musical elements comprise prerecorded music segment played with various musical instruments.

14. The electronic screen device as recited in claim 12, wherein the musical elements comprise pitch contour, frequency range, rhythm elements of corresponding symbolic language segment of a visual object.

15. The electronic screen device as recited in claim 12, wherein the musical elements comprise acoustic features consistent with non-speech features of infant-directed speech mothers use in pre-verbal interactions with babies.

16. The electronic screen device as recited in claim 12, wherein the visual objects comprise visual representations of objects and visual language elements.

17. The electronic screen device as recited in claim 12, wherein the spoken language elements comprise audio recordings of language segments by actual speakers and vocalists.

18. The electronic screen device as recited in claim 12, wherein the kinetic elements comprise moving a limb to use the device.

19. The electronic screen device as recited in claim 12, wherein the compositional elements configured to stimulate an individual's multisensory perception.

20. The electronic screen device as recited in claim 12, wherein the compositional elements configured to stimulate an individual's auditory object formation.

21. The electronic screen device as recited in claim 12, wherein the compositional elements configured to stimulate an individual's awareness of an object.

22. The electronic screen device as recited in claim 12, wherein the compositional elements configured to stimulate an individual's attention.

23. The electronic screen device as recited in claim 12, wherein the compositional elements configured to stimulate an individual's auditory perception.

24. The electronic screen device as recited in claim 12, wherein the compositional elements configured to stimulate an individual's auditory-object perception.

25. The electronic screen device as recited in claim 12, wherein the compositional elements configured to stimulate an individual's auditory-object processing.

26. The electronic screen device as recited in claim 12, wherein the compositional elements configured to stimulate an individual's pitch processing and/or perception.

27. The electronic screen device as recited in claim 12, wherein the compositional elements configured to stimulate an individual's timbre perception.

28. The electronic screen device as recited in claim 12, wherein the compositional elements configured to stimulate an individual's cognition.

29. The electronic screen device as recited in claim 12, wherein the compositional elements configured to stimulate an individual's ability of grouping acoustic features into objects.

30. The electronic screen device as recited in claim 12, wherein the compositional elements configured to stimulate an individual's ability of assigning objects to categories and patterns.

31. The electronic screen device as recited in claim 12, wherein the compositional elements configured to stimulate an individual's categorical perception.

32. The electronic screen device as recited in claim 12, wherein the compositional elements configured to stimulate an individual's auditory object recognition.

33. The electronic screen device as recited in claim 12, wherein the compositional elements configured to stimulate an individual's selective attention to auditory scene component objects.

34. The electronic screen device as recited in claim 12, wherein the compositional elements configured to stimulate an individual's pitch processing and perception.

35. The electronic screen device as recited in claim 12, wherein the compositional elements configured to stimulate an individual's receptive spoken language and visual language development.

36. The electronic screen device as recited in claim 12, wherein the compositional elements configured to stimulate an individual's auditory and/or visual memory.

37. The electronic screen device as recited in claim 12, wherein the compositional elements configured to stimulate an individual's semantic and/or syntactic development.

38. The electronic screen device as recited in claim 12, wherein the compositional elements configured to stimulate an individual's receptive phrasal speech.

39. The electronic screen device as recited in claim 12, wherein the compositional elements configured to stimulate an individual's symbolic thinking.

40. The electronic screen device as recited in claim 12, wherein the compositional elements configured to stimulate an individual's kinesthetic use of limbs.

41. A method for therapeutically using music to treat a disorder comprising:
evaluating an individual's receptive language and general auditory processing state and apparatus to determine auditory processing and receptive language rehabilitation needs and dysfunctions associated with the disorder;
selecting the developmentally appropriate level of the electronic screen device program for multisensory use to the individual including compositional features selected to treat the determined auditory processing and receptive language rehabilitation and development needs and dysfunctions;
using an electronic screen device to be used by the individual by combining audiovisual and kinesthetic functions in hierarchical order with increasing difficulty and
repeating the step of using an electronic screen device to be used by the individual by combining audiovisual and kinetic functions according to a treatment schedule designed to treat the disorder.

42. A method as recited in claim 41, wherein the disorder is a disorder selected from the group consisting of
nonverbal and minimally verbal autism
autism spectrum disorders;
communication disorders
hearing disorders
language disorders
brain trauma
PTSD
Stroke;
cognitive dysfunction;
psychiatric and neurological disorders;
neurodevelopmental disorders;

43. A method for creating a therapeutic musical composition comprising:
taking an initial syllabic rhythm of a language segment;
composing and incorporating a pitch contour, pitch range, and timbre component into the syllabic rhythm;
incorporating tempo elements into the syllabic rhythm, the tempo elements being configured to constructively interact with an individual's perception;
incorporating changes of volume into the syllabic rhythm, the changes of volume being configured to stimulate an individual's attention and perception and
selecting and incorporating frequency spectrums into the syllabic rhythm to stimulate an individual's attention and perception
whereby a musical composition is created that when used in conjunction of visual objects and kinesthetic movement in a predetermined sequence to be consistent with auditory processing development will better stimulate auditory processing and receptive language acquisition.
